(19) United States
(12) Patent Application Publication
(10) Pub. No.: US 2014/0067241 A1
(43) Pub. Date: Mar. 6, 2014

(54) POWER-SOURCE APPARATUS FOR VEHICLE AND CONTROL METHOD OF THE SAME

(71) Applicant: MAZDA MOTOR CORPORATION, Hiroshima (JP)

(72) Inventors: Masamitsu YUHARA, Hiroshima-city (JP); Katsumasa YOSHIDA, Hiroshima-city (JP); Kazuya KOTANI, Hiroshima-city (JP)

(73) Assignee: MAZDA MOTOR CORPORATION, Hiroshima (JP)

(21) Appl. No.: 13/962,759

(22) Filed: Aug. 8, 2013

(30) Foreign Application Priority Data
Aug. 31, 2012 (JP) 2012-191175

(51) Int. Cl. F02D 45/00

(52) U.S. Cl. CPC F02D 45/00
USPC 701/112

(57) ABSTRACT

The present invention relates to a power-source apparatus for a vehicle comprising a generator driven by an engine of the vehicle having a function of an idle stop and generating power, a power-storage device storing the power generated by the generator thereat, and a control device. The power-storage device supplies the power to an electric load of the vehicle when the engine is stopped by means of the idle stop. The control device is configured to restart the engine when a voltage of the power-storage device decreases below a lower-limit value after the engine is stopped by means of the idle stop, and stop the engine again when a specified requirement for determining a sufficient recovery of the voltage of the power-storage device by means of the engine's restart is met.

### BACKGROUND OF THE INVENTION

The present invention relates to a power-source apparatus for a vehicle and a control method of the same, which comprises a generator driven by an engine of the vehicle having a function of an idle stop and generating power and a power-storage device storing the power generated by the generator thereat.

An apparatus disclosed in Japanese Patent Laid-Open Publication No. 2009-180125, for example, is known as a power-source apparatus for a vehicle which comprises a generator and a power-storage device. The power-source apparatus disclosed in this patent document is applicable to any vehicle having a function of an idle stop (a so-called idle-stop function) which is capable of automatically stopping and restarting an engine of the vehicle. Herein, a capacitor having a high capacity which is capable of storing power through a process jointly using a chemical reaction (a hybrid capacitor) is used as the above-described power-storage device.

The capacitor (hybrid capacitor) used in the above-described patent document has properties in which the lower its voltage is, the more it deteriorates. Accordingly, according to the apparatus of the above-described patent document, the idle stop is prohibited when the voltage of the capacitor decreases below a specified threshold in order to prevent deterioration of the durability of the capacitor.

Herein, in a case in which the engine is stopped by means of the idle stop, power which is to be consumed by an electric load (an air conditioner and an audio device, for example) which operates while the engine is stopped may be supplied from the power stored at the above-described capacitor. In this case, the voltage of the capacitor decreases gradually, so that if the engine's stop by means of the idle stop lasts long, the voltage of the capacitor decreases greatly. Consequently, the voltage of the capacitor may become improperly low, so that the capacitor deteriorates, or in the worst case, no further power may be supplied from the capacitor to the electric load, so that operation of the electric load comes to be stopped.

Then, it has been proposed in order to avoid the above-described situation that the above-described threshold is properly set, considering the voltage decrease during the engine's stop, so that the idle stop is prohibited when the voltage of the capacitor becomes lower than this threshold. In this case, however, the idle stop can be operative only when the voltage of the capacitor is considerably high. Therefore, the idle stop may not happen properly often, so that advantages of the idle stop, such as an improvement of the fuel economy (gas millage), may not be achieved properly.

### SUMMARY OF THE INVENTION

The present invention has been devised in view of the above-described matters, and an object of the present invention is to provide a power-source apparatus for a vehicle and a control method of the same which can properly enlarge an operation chance of the idle stop, ensuring the necessary voltage of the power-storage device.

According to the present invention, there is provided a power-source apparatus for a vehicle, comprising a generator driven by an engine of the vehicle having a function of an idle stop and generating power, a power-storage device storing the power generated by the generator thereat, and a control device controlling a stop of the engine, a restart of the engine, and a generation operation of the generator, wherein the power-storage device supplies the power to an electric load of the vehicle when the engine is stopped by means of the idle stop, and the control device is configured to restart the engine when a voltage of the power-storage device decreases below a lower-limit value after the engine is stopped by means of the idle stop, and stop the engine again when a specified requirement for determining a sufficient recovery of the voltage of the power-storage device by means of the engine's restart is met.

According to the present invention, when the voltage of the power-storage device decreases below the lower-limit value, the engine is compulsorily restarted and thereby the power generation by the generator is restarted even while the engine is stopped by means of the idle stop. Thereby, the voltage of the power-storage device which decreases during the engine's stop can be recovered properly. Further, the engine is stopped again when the voltage of the power-storage device exceeds a threshold higher than the lower-limit value, for example, so that the voltage of the power-storage device recovers sufficiently. Thereby, the fuel economy can be effectively improved and also the voltage of the power-storage device can be kept above the lower-limit value all the time (the proper operation of the electric load can be ensured).

According to an embodiment of the present invention, the above-described power-storage device is a capacitor. The capacitor to physically absorb electric charges is capable of quickly storing the power generated by the generator thereat, and also has the linear charging/discharging properties so as to be used properly as the above-described power-storage device. Herein, the concept (kind) of this capacitor includes not only a normal type of electric double-layer capacitor but also a hybrid capacitor which is capable of storing power through a process jointly using a chemical reaction, such as a Lithium ion capacitor.

According to another embodiment of the present invention, the above-described specified requirement is that the voltage of the power-storage device exceeds a threshold which is higher than the lower-limit value. Thereby, it can be determined properly based on the voltage of the power-storage device that the specified requirement is met (i.e., the power-storage device has been charged sufficiently).

According to another embodiment of the present invention, the above-described threshold is set valuably in accordance with a decrease rate of the voltage of the power-storage device which decreases when the engine is stopped by means of the idle stop. Thereby, a passenger in the vehicle does not have any uncomfortable feelings which may be caused by a frequent repeat of the engine's stop and restart.

According to another embodiment of the present invention, the above-described specified requirement is that an operation time of the engine after the engine is restarted reaches a specified time. Thus, the determination of the specified requirement being met can be made properly based on the operation time of the engine after the engine's restart as well.

According to another embodiment of the present invention, the above-described control device is configured to cancel the idle stop when a total time of the engine being stopped after the idle stop reaches an upper-limit value, and set the specified time variably in accordance with a remaining time which is obtained by subtracting, from the upper-limit value, a time of the engine being stopped until the voltage of the power-storage device decreases below the lower-limit value. Thereby, the power stored at the power-storage device by the engine's restart can be increased more as the time of the engine's stop (remaining time) becomes longer. Accordingly, the appropriate amount of power which corresponds to the power which is supposed to be consumed while the engine is stopped can be properly generated by the generator.

According to another embodiment of the present invention, the above-described control device is configured to set an engine speed after the engine's restart variably in accordance with a time which has passed from the engine's stop to the timing the voltage of the power-storage device decreases below the lower-limit value. Alternatively, the control device is configured to set an engine speed after the engine's restart variably in accordance with a decrease rate of the voltage of the power-storage device which decreases when the engine is stopped by means of the idle stop. According to these, the engine speed after the engine's restart changes in accordance with the speed of the consumption of the power of the power-storage device (the magnitude of the power which an electric load consumes per unit time). Thereby, by increasing the power-generation efficiency more as the consumption speed of the power becomes faster, for example, the time to be required for recovering the voltage of the power-storage device can be controlled within a constant range regardless of the operation situation of the electric load.

Further, according to another aspect of the present invention, there is provided a control method of a power-source apparatus for a vehicle which comprises a generator driven by an engine of the vehicle having a function of an idle stop and generating power and a power-storage device storing the power generated by the generator thereat, and the power is supplied from the power-storage device to an electric load of the vehicle when the engine is stopped by means of the idle stop, the method comprising steps of restarting the engine when a voltage of the power-storage device decreases below a lower-limit value after the engine is stopped by means of the idle stop, and stopping the engine again when a specified requirement for determining a sufficient recovery of the voltage of the power-storage device by means of the engine's restart is met. This control method can provide the same operations and effects as the above-described power-source apparatus.

Other features, aspects, and advantages of the present invention will become apparent from the following description which refers to the accompanying drawings.

### BRIEF DESCRIPTION OF THE DRAWINGS

FIG. 1 is a diagram showing a schematic constitution of a vehicle equipped with a power-source apparatus according to a first embodiment of the present invention.

FIG. 2 is a block diagram showing a control system of the vehicle.

FIG. 3 is time charts showing control operations of the first embodiment at the time of an idle stop.

FIG. 4 is a flowchart showing the control operations of the first embodiment at the time of the idle stop.

FIG. 5 is time charts showing control operations of a second embodiment of the present invention at the time of the idle stop.

FIG. 6 is flowchart showing the control operations of the second embodiment at the time of the idle stop.

### DETAILED DESCRIPTION OF THE INVENTION

### Embodiment 1

(1) Whole Constitution of Vehicle

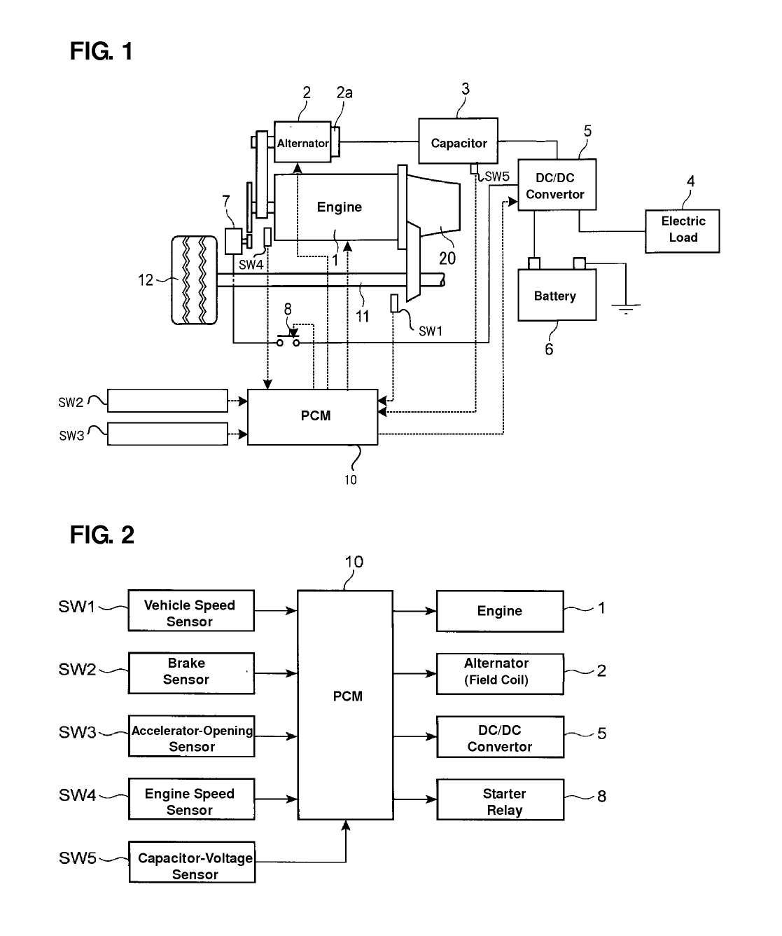

FIG. 1 is a diagram showing a schematic constitution of a vehicle equipped with a power-source apparatus according to a first embodiment of the present invention. FIG. 2 is a block diagram showing a control system of the vehicle. A vehicle shown in the figures comprises an engine 1 which is a power source for driving, an alternator 2 (corresponding to a generator of the present invention) which is driven by the engine 1 and generates power, a capacitor 3 (corresponding to a power-storage device of the present invention) which is electrically coupled to the alternator 2 and stores the power generated by the alternator 2, a starter motor 7 which provides the engine 1 with a rotational force when the engine 1 is started, an electric load 4 which is comprised of an air conditioner, an audio device, lamps, meters and so on, a DC/DC convertor 5 which is provided between the electric load 4 and the alternator 2, a battery 6 which is coupled to the DC/DC convertor 5, and a PCM 10 (corresponding to a control device of the present invention).

The starter motor 7 is electrically coupled to the DC/DC convertor 5, and a starter relay 8 is provided on a line interconnecting them. The starter relay 8 is turned ON when the engine 1 is started, and turned OFF at the other time. When the starter relay 8 is turned ON at the time of an engine's start, the power stored at the battery 6 is supplied to the starter motor 7 via the DC/DC convertor 5, whereby the starter motor 7 can be driven. The starter motor 7 compulsorily rotates a ring gear fixed to an output shaft (crankshaft) of the engine 1, thereby providing the engine 1 with a rotational force.

The vehicle of the present embodiment is a vehicle having a function of an idle stop (a so-called idle-stop function) which is capable of automatically stopping the engine 1 on a specified condition even when an ignition is ON. Accordingly, the starter motor 7 is operated so as to be driven not only when the ignition is turned ON from its OFF state but also when the engine is restarted from its automatically-stopped state.

The engine 1 is connected to a transmission 20, and a driveshaft 11 and wheels 12 are provided at an output side of the transmission 20. While the vehicle accelerates, an output torque of the engine 1 is transmitted to the driveshaft 11 and the wheels 12 by way of the transmission 20, thereby driving and rotating the wheels 12. Meanwhile, while the vehicle decelerates, no torque is outputted from the engine 1 and the engine 1 is driven and rotated by the wheels 12 and the driveshaft 11 which are under rotation due to the force of inertia.

The alternator 2 is coupled to the output shaft of the engine 1 via a belt or the like to receive the drive force from the engine 1. Specifically, the alternator 2 comprises a rotor (not illustrated) which rotates together with the output shaft of the engine 1 and a stator coil (not illustrated) which is arranged around the rotor. Some field coils for generating the magnetic field are wound up around the rotor. At the time of power generation by the alternator 2, the electricity is supplied to the field coils, and the rotor rotates in the magnetic filed generated, whereby the power can be generated.

The alternator 2 includes a rectifier 2a therein which converts the power generated by the alternator 2 from the alternating current to the direct current. That is, the power generated by the alternator 2 is converted to the direct current by the rectifier 2a and then supplied to the capacitor 3.

The battery 6 is a rechargeable (secondary) battery, such as an ordinary Pb (Lead) battery for vehicle. This kind of battery 6 stores the electric energy through the chemical reaction, so that it has the properties in which it is inferior in quick charging/discharging but it can store a relatively large amount of power (i.e., the capacity of power storage is high).

The capacitor 3 is a high-capacity electric double-layer capacitor (EDLC) which can store the voltage up to 25 V. This capacitor 3 stores the electricity through a physical absorption of an electrolytic ion, differently from the chargeable battery of the battery 6, so that the capacitor 3 has the properties in which it is capable of performing a relatively quick charging/discharging and having a lower internal resistance.

The power generation by the alternator 2 is conducted intensively at the time of deceleration of the vehicle, and the generated power (regenerative power) is stored at the capacitor 3 once. The voltage of the power of the maximum 25 V stored at the capacitor 3 is decreased to 12 V by the above-described DC/DC convertor 5, and then supplied to the electric load 4 or the battery 6. Accordingly, since the more power is generated by the alternator 2 when the deceleration of the vehicle happens frequently, most of the power required during the vehicle traveling may be supplied from the above-described regenerative power. For example, when the vehicle travels in the town, the acceleration/deceleration of the vehicle is generally repeated frequently. Therefore, in most cases, before the power stored at the capacitor 3 is exhausted (consumed), the vehicle decelerates again and thereby the regenerative power is ensured. Thus, it may be unnecessary to consume the power from the battery 6 (the power discharged from the battery 6 and supplied to the electric load 4).

Meanwhile, at the time of acceleration of the vehicle, no power generation by the alternator 2 happens basically in order to decrease the resistance torque applied to the engine 1 from the alternator 2 as much as possible. In this case, the consumptive power of the electric load 4 is supplied from the power already stored at the capacitor 3 and the power discharged from the battery 6 at need.

Components of a powertrain system including the engine 1 are totally controlled by the PCM 10. The PCM 10 is a microprocessor which is comprised of CPU, ROM, RAM and so on, which is well known.

Various information-signals from plural sensors provided at the vehicle are inputted to the PCM 10. That is, the vehicle is equipped with a vehicle-speed sensor SW1 to detect a traveling speed of the vehicle (vehicle speed), a brake sensor SW2 to detect an operational force (pressing force) of a brake pedal, not illustrated, an accelerator-opening sensor SW3 to detect an opening of an accelerator, not illustrated, an engine-speed sensor SW4 to detect a rotational speed of an output shaft of the engine 1 (i.e., an engine speed), and a capacitor-voltage sensor SW5 to detect a voltage of the capacitor 3 (voltage between terminals). These sensors SW1-SW5 are electrically coupled to the PCM 10.

The PCM 10 is also electrically coupled to various controllable devices of the engine 1 (fuel injectors and ignition plugs, for example), the filed coils of the alternator 2, the DC/DC convertor 5, and the starter relay 8, and it outputs control signals for operation to these.

That is, the PCM 10 conducts, based on various information from the above-described sensors SW1-SW5, a control of combustion of the engine 1 so as to provide an appropriate torque according to a vehicle traveling state, a control of the amount of power generation of the alternator 2 according to the vehicle traveling state, and a control of a supply of the power generated by the alternator 2 to the electric load 4 and the battery 6.

Further, the vehicle of the present embodiment is the one having a so-called idle stop function, so the above-described PCM 10 has a function which is capable of automatically stopping the engine 1 on a specified condition as well as restarting the engine being stopped.

(2) Power-Generation Control at Time of Idle Stop

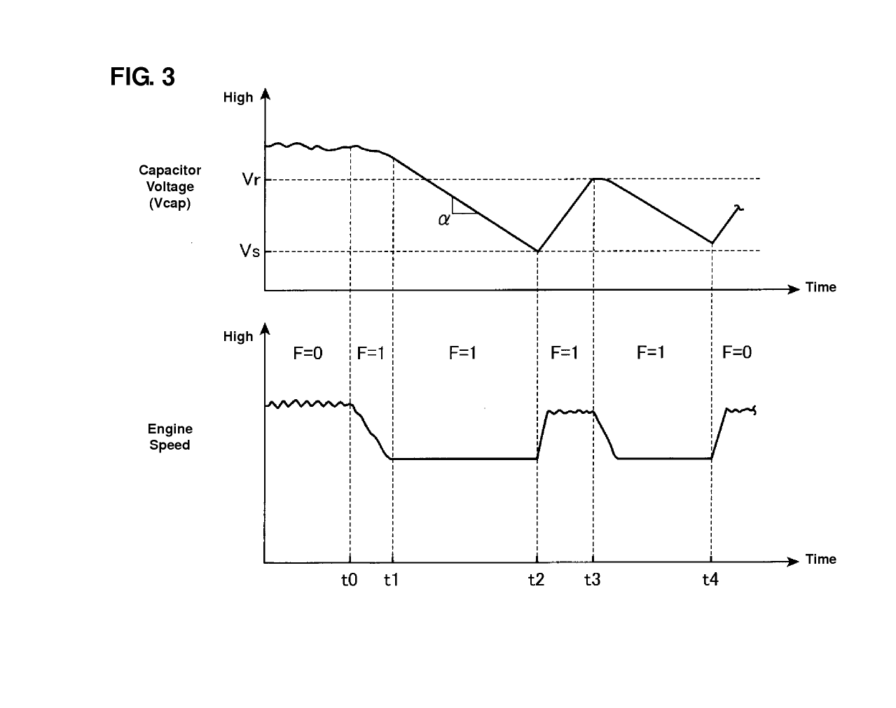

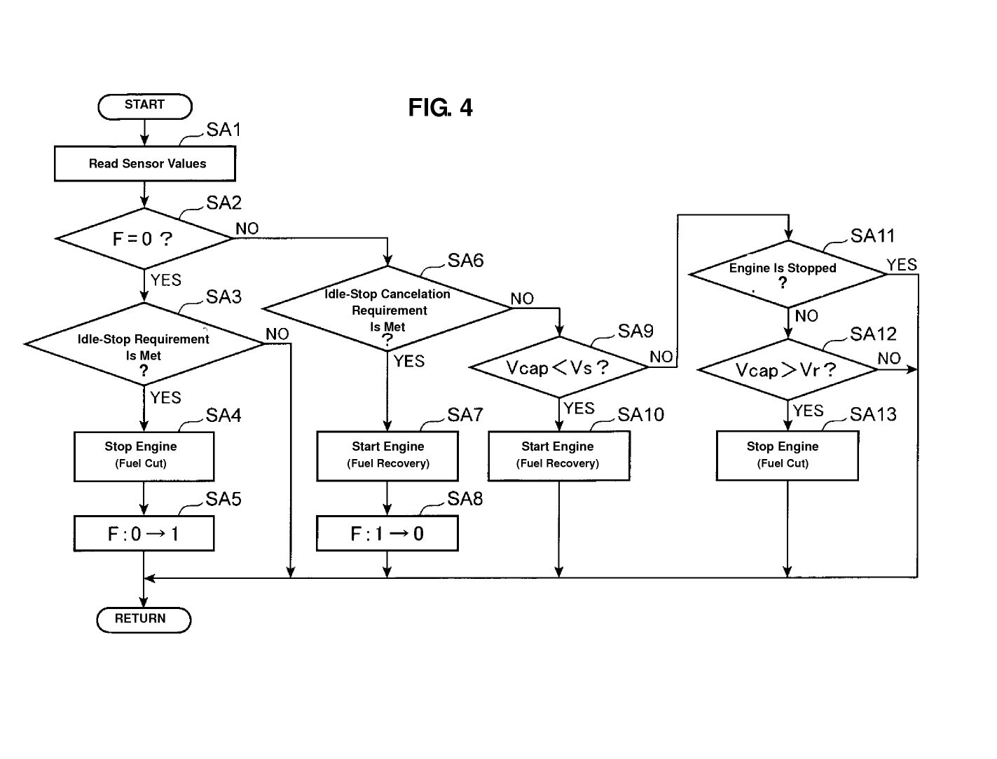

Next, the power generation of the alternator 2 when the engine is stopped by means of the idle stop will be described specifically. FIG. 3 is time charts showing changes of the voltage of the capacitor 3 and the engine speed at the time of the idle stop. FIG. 4 is a flowchart showing steps of control operations of the PCM 10 at the time of the idle stop.

When the flowchart shown in FIG. 4 starts, the PCM 10 executes processing of reading-in the detection values of the sensors (step SA1). Specifically, the PCM 10 reads in the detection signals of the vehicle-speed sensor SW1, the brake sensor SW2, the accelerator-opening sensor SW3, the engine-speed sensor SW4, and the capacitor-voltage sensor SW5, and, based on these signals, obtains various information on the vehicle speed, the pressing force of the brake pedal, the opening of the accelerator, the voltage of the capacitor 3, and so on.

Subsequently, the PCM 10 executes processing of determining whether or not an idle-stop flag F is “0” (step SA2). The idle-stop flag F is a value which changes in accordance with whether or not an idle-stop requirement and an idle-stop cancelation requirement are met, which will be described. Herein, the idle-stop flag F is set “1” during only the term from the timing of the idle-stop requirement being met to the timing of the idle-stop cancelation requirement being met. Accordingly, the idle-stop flag F is set “0” during the term from the timing of starting the vehicle driving to the timing of the idle-stop requirement being met for the first time, and during the term from the timing of the idle-stop cancelation requirement being met to the timing of the idle-stop requirement being met at the next time.

When the determination made in the step SA2 is YES and it is confirmed that the idle-stop flag F is “0”, the PCM 10 executes processing of determining whether or not the idle-stop requirement for automatically stopping the engine is met based on the information obtained in the step SA1 (step SA3). Herein, it is determined that the idle-stop requirement is met when plural requirements, such that the vehicle stops, the accelerator opening is zero (accelerator OFF), the pressing force of the brake pedal is a specified value or greater (brake ON), and the voltage of the capacitor 3 is a specified value or greater, for example, are all met.

In this case, the requirement of the voltage of the capacitor 3 being the specified value or greater, which is one of the above-described requirements in the step SA3, is the one which aims at utilizing the power stored at the capacitor 3 as the consumptive power of the electric load 4 during the engine's stop. Herein, the above-described “specified value” regarding the voltage of the capacitor 3 can be properly set considering the amount of consumptive power of the electric load 4 and the like, and may be set at a value equal to a threshold Vr which will be described later, for example.

When the determination made in the step SA3 is YES and it is confirmed that the idle-stop requirement has been met, the PCM 10 executes processing of stopping the engine 1 by cutting a fuel supply to the engine 1 as well as processing of rewriting the idle-stop flag F from “0” to “1” (steps SA4, SA5).

In the time charts of FIG. 3, the timing t0 shows a point when the idle-stop requirement has been met. As shown in this figure, when the idle-stop requirement has been met at the timing t0 and thereby the fuel cut is executed, the engine 1 continues to rotate due to the force of its inertia for a short period of time, and then finally stops (the engine speed becomes zero) at the timing t1 which is later than the timing t0. Meanwhile, the idle-stop flag F is rewritten from “0” (before the timing t0) to “1” (after the timing t0).

When the idle-stop flag F is rewritten from “0” to “1” at the timing of the idle-stop requirement being met as descried above, the determination made in the above-described step SA2 is NO. In this case, the PCM 10 executes processing of determining whether or not the idle-stop cancelation requirement is met based on the information obtained in the step SA1 (step SA6). Herein, it is determined that the idle-stop cancelation requirement has been met when at least one of plural requirements, such that the pressing force of the brake pedal is smaller than the specified value (brake OFF), the accelerator is pressed (accelerator ON), and the total time of the engine's stop after the idle stop reaches a specified limit value, for example, is met.

When the determination made in the step SA6 is NO and it is confirmed that the idle-stop cancelation requirement has not been met yet, the PCM 10 executes processing of determining whether or not the voltage (which is also denoted by Vcap in the figures) of the capacitor 3 obtained in the step SA1 is smaller than a predetermined lower-limit value Vs (step SA9). This lower-limit value Vs is a minimum voltage for making the electric load 4 operate (the air conditioner, the audio device, etc.) properly, and therefore if the voltage of the capacitor 3 is maintained at this lower-limit value Vs or greater, the operation of the electric load 4 can be ensured. More specifically, the lower-limit value Vs is determined, considering the consumptive power of any of the electric load 4 which operates currently, such that the more the currently-consumed power of the electric load 4 is, the greater the lower-limit value Vs to be set is, and, on the other hand, that the less the currently-consumed power of the electric load 4 is, the smaller the lower-limit value Vs to be set is.

When the determination made in the step SA9 is YES and it is confirmed that the voltage (Vcap) of the capacitor 3 has deceased below the above-described lower-limit value Vs, the PCM 10 executes processing of restarting the engine 1 (step SA10). That is, the PCM 10 turns ON the starter relay 8, thereby operating (driving) the starter motor 7, and recovers the fuel supply to the engine 1, so that the engine 1 is restarted.

In the time charts of FIG. 3, the timing the voltage of the capacitor 3 decreases below the lower-limit value Vs is denoted by t2. During the term from the timing t1 to the timing t2, the power generation by the alternator 2 is stopped so that no power is supplied to the capacitor 3 and the power stored at the capacitor 3 is consumed by the electric load 4. Accordingly, the voltage of the capacitor 3 gradually lowers during the term from the timing t1 to the timing t2. Then, the voltage of the capacitor 3 decreases below the lower-limit value Vs finally at the timing t2, so that the engine 1 is restarted at this point.

When the engine 1 is restarted at the timing t2, the engine speed of the engine 1 increases and then moves to its idling operation. Herein, since the power generation of the alternator 2 is restarted and this generated power is supplied to the capacitor 3, the voltage of the capacitor 3 increases gradually after the timing t2.

While the engine 1 is restarted at the timing t2, this restart is not the one which is caused by the above-described idle-stop cancelation requirement (SA6) being met. Therefore, the idle-stop flag F is not changed, but still remains “1”.

The voltage of the capacitor 3 recovers due to the restart of the engine 1, and then increases above the above-described lower-limit value Vs, so that the determination made in the step SA9 becomes NO. The PCM 10 executes processing of determining whether or not the engine 1 stops, that is, whether or not the engine speed of the engine 1 is zero (step SA11).

Since the engine speed of the engine 1 is greater than zero, of course, after the timing t2 the engine is restarted, the determination made in the step SA11 is NO. Then, the PCM 10 executes processing of determining whether or not the voltage (Vcap) of the capacitor 3 is greater than a predetermined threshold Vr (step SA12). This threshold Vr is a value for ensuring that the sufficient power is stored at the capacitor 3, which is set at a value greater than the lower-limit value Vs. Herein, the voltage recovering to the value greater than the threshold Vr means that the specified requirement has been met according to the present invention.

When the determination made in the step SA12 is YES and it is confirmed that the voltage of the capacitor 3 has increased above the threshold Vr, the PCM 10 executes processing of stopping the engine 1 by cutting the fuel supply to the engine 1 (step SA13).

In the time charts of FIG. 3, the timing the voltage of the capacitor 3 increases above the threshold Vr is denoted by t3. The fuel supply is cut at this timing t3, so that the engine 1 comes to stop completely in a short time after the timing t3. Thereby, the power generation by the alternator 2 stops and therefore the voltage of the capacitor 3 comes to decrease again.

The voltage of the capacitor 3 is watched continuously after this as well. When the voltage of the capacitor 3 decreases below the above-described lower-limit value Vs again, the engine 1 is restarted for storing the power at the capacitor 3 again at this point. In the example shown in FIG. 3, the idle-stop cancelation requirement (SA6) is met at the timing t4 before the voltage of the capacitor 3 decreases below the lower-limit value Vs.

When the idle-stop cancelation requirement has been met (i.e., the determination made in the step SA6 is YES), the PCM 10 executes processing of restarting the engine 1 by operating (driving) the starter motor 7 and also recovering the fuel supply to the engine 1 (step SA7). Further, at the same time, the PCM 10 executes processing of rewriting the idle-stop flag F from “1” to “0” (step SA8). Accordingly, as shown in the time charts after the timing t4 of FIG. 3, the operation of the engine 1 is restarted, and the engine's operation continues until the idle-stop requirement has been met again.

(3) Operations

As described above, according to the first embodiment, the following features are adopted to the power-source apparatus for the vehicle which comprising the alternator 2 (generator) driven by the engine 1 of the vehicle having the function of the idle stop and generating the power, the capacitor 3 (power-storage device) storing the power generated by the generator 2 thereat, and the PCM 10 (control device) controlling the stop of the engine 1, the restart of the engine 1, and the generation operation of the alternator 2.

When the engine 1 is stopped by means of the idle stop, the power is supplied to the electric load 4 (air conditioner, audio device, etc.) from the capacitor during the engine's stop. The PCM 10 restarts the engine 1 when the voltage of the capacitor 3 decreases below the lower-limit value Vs after the above-described stop of the engine 1 (at the timing t2 of FIG. 3), and stops the engine 1 again when the voltage of the capacitor 3 increases above the threshold Vr in accordance with the above-described restart of the engine 1 (at the timing t3 of FIG. 3). Accordingly, the necessary voltage of the capacitor 3 can be ensured, and also the operation chance of the idle stop can be properly enlarged.

That is, according to the first embodiment, when the voltage of the capacitor 3 decreases below the lower-limit value Vs during the stop of the engine 1 by means of the idle stop, the engine 1 is compulsorily restarted and thereby the power generation by the alternator 2 is restarted even when the idle-stop cancelation requirement is not met. Thereby, the voltage of the capacitor 3 which decreases during the engine's stop can be recovered. Further, the engine 1 is stopped again when the voltage of the capacitor 3 increases above the threshold Vr higher than the lower-limit value Vs so that the voltage of the capacitor 3 has recovered sufficiently. Thereby, the fuel economy can be effectively improved and also the voltage of the capacitor 3 can be kept above the lower-limit value Vs all the time (the operations of the electric load 4 can be ensured).

For example, if the above-described temporary engine's restart for keeping the voltage of the capacitor 3 above the lower-limit value Vs (the restart from the timing t2 to the timing t3 shown in FIG. 3) did not exist, the voltage of the capacitor 3 would go down more below the lower-limit value Vs after the timing t2 of FIG. 3 so that the electric load 4 of the vehicle could not operate properly. Herein, it may be considered, of course, that the resource of the power supply to the electric load 4 is changed (switched) from the capacitor 3 to the battery 6 when the voltage becomes smaller than the lower-limit value Vs. However, since the voltage of the battery 6 decreases quickly for operating (driving) the starter motor 7 at the time of the restart of the engine 1, if the power supply to the electric load 4 relies on the battery 6, there is a concern that the electric load 4 may not operate properly at the time of the restart of the engine 1. Therefore, according to the above-described embodiment, the consumptive power of the electric load 4 during the stop of the engine 1 is supplied from the capacitor 3, not from the battery 6. In this case, however, since it is necessary that the voltage of the capacitor 3 is kept above the lower-limit value Vs for making the electric load 4 operate properly, the engine 1 is restarted temporarily so that the sufficient voltage of the capacitor 3 can be recovered even before the idle-stop cancelation requirement has been met.

In order to keep the voltage of the capacitor 3 above the lower-limit value Vs without having the temporary restart of the engine 1, it may be necessary that the voltage of the capacitor 3 is made considerably high prior to the engine's stop (for example, the idle stop is not permitted unless the full power is not stored at the capacitor 3), or the idle stop is controlled so as to continue only for a period of time until the voltage of the capacitor 3 decreases below the lower-limit value Vs. However, the former has a problem in that the frequency of the idle stop may be improperly low, whereas the latter has a problem in that the upper-limit continuation time of the idle stop may become so short that the fuel economy may not be improved properly.

By contrast, according to the above-described embodiment, even when the voltage of the capacitor 3 decreases during the engine's stop by means of the idle stop, the voltage of the capacitor 3 is recovered by the temporary engine's restart, and then the engine is restarted. Thereby, the necessary voltage of the capacitor 3 can be ensured, and also the operation chance of the idle stop can be enlarged.

Herein, while the above-described embodiment does not refer to setting of a specific value of the engine speed at the engine being restarted temporarily during the engine's stop by means of the idle stop, more specifically, the engine speed during the term from the timing the engine's rotation becomes stable to the timing the fuel supply is cut again is not referred to in the above-described embodiment, the engine speed after the engine's restart after the timing t2 may be set variably in accordance with the magnitude of the power which the electric load 4 consumes.

For example, it can be considered that the time which has passed from the stop of the engine 1 to the timing the voltage of the capacitor 3 decreases below the lower-limit value Vs (the passing time from the timing t1 to the timing t2 shown in FIG. 3) is detected and the engine speed after the engine's restart after the timing t2 is set at a higher speed when the above-described passing time is shorter.

Also, it can be considered that a decrease rate of the voltage of the capacitor 3 which decreases when the engine 1 is stopped (the timing t1-t2), that is, an incline a shown in FIG. 3, is detected and the engine speed after the engine's restart after the timing t2 (the engine speed during the timing t2-t3) is set at a higher speed when the above-described decrease rate (incline) α is greater.

According to these embodiments, the faster the consumption speed of the power of the capacitor 3 is, the higher the engine speed is. Thereby, the efficiency of the power generation by the alternator improves, so that the power generation can be conducted with an appropriate efficiency which corresponds to the consumption speed of the power (the magnitude of the power which the electric load 4 consumes per unit time). Thereby, the time to be required for recovering the voltage of the capacitor 3 above the threshold Vr (the timing t2-t3) can be controlled within a constant range regardless of the operation situation of the electric load 4.

Further, it can be considered that the decrease rate of the voltage of the capacitor 3 which decreases when the engine 1 is stopped (the timing t1-t2), that is, the incline α shown in FIG. 3, is detected and the threshold (the threshold Vr at the timing t3) for stopping the engine again is set at a higher value when the decrease rate (incline) a is greater.

According to this embodiment, the faster the consumption speed of the power of the capacitor 3 is, the more the amount of power stored at the capacitor 3 is. Thereby, a passenger in the vehicle does not have any uncomfortable feelings which may be caused by a frequent repeat of the engine's stop and restart (three times or more, for example).

In the first embodiment, the engine 1 is restarted at the timing t2 in order to recover the voltage of the capacitor 3 during the engine's stop, and then the engine 1 is stopped again at the timing t3 the voltage of the capacitor 3 increases above the threshold Yr. However, it is not necessary that the timing for stopping the engine is set directly based on the voltage of the capacitor 3, but this engine's stop timing can be set at any timing as long as it seems that the voltage of the capacitor 3 has recovered sufficiently. Such an alternative will be described below as a second embodiment.

### Embodiment 2

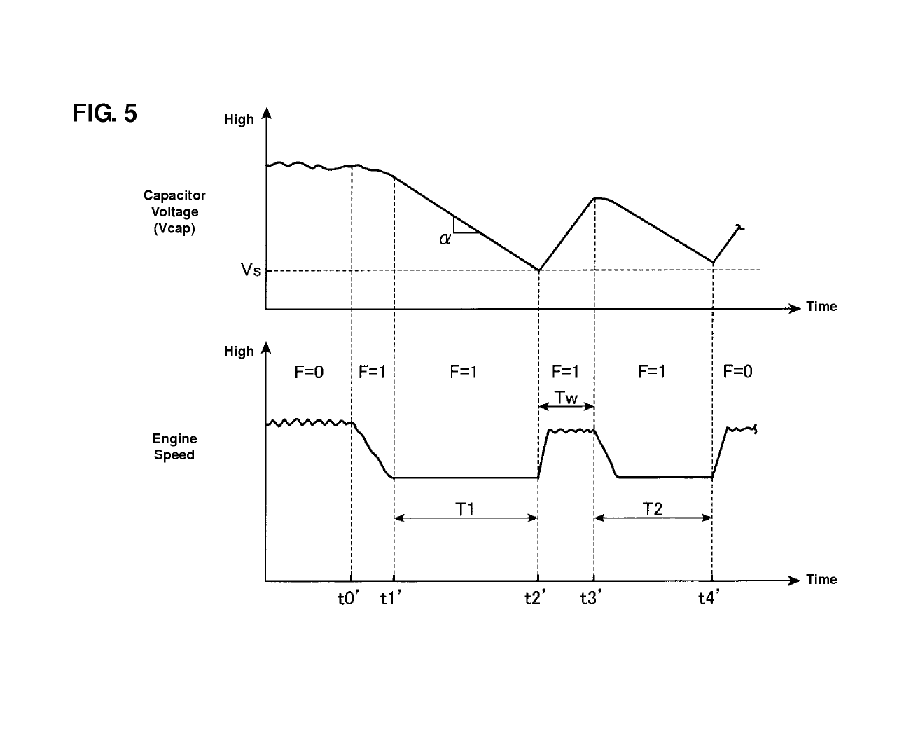

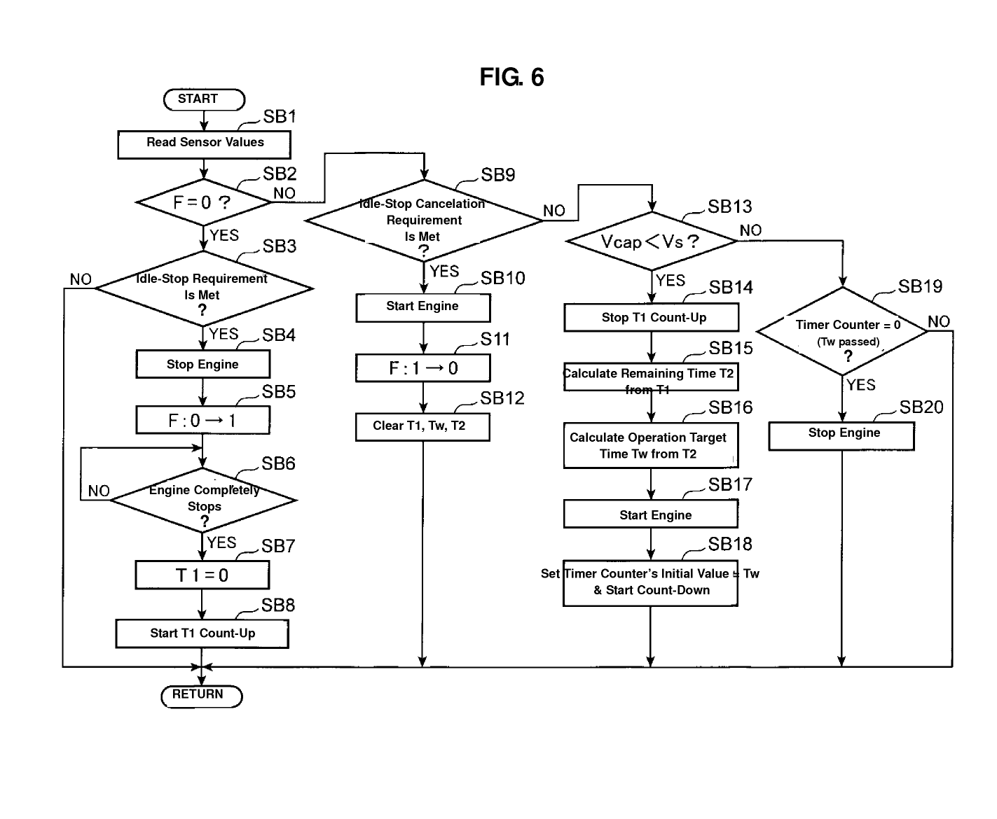

FIGS. 5 and 6 are time charts and a flowchart which describe a second embodiment of the present invention. In the second embodiment, all of the basic constitutions of the vehicle are the same, and therefore descriptions of those are omitted here.

When the flowchart shown in FIG. 6 starts, the PCM 10 reads in the detection values of the sensors (step SB1) and determines whether or not the idle-stop flag F is “0” (step SB2). When the idle-stop flag F is “0”, the PCM 10 determines whether or not the idle-stop requirement is met (step SB3). When the determination is YES, the PCM 10 executes processing of stopping the engine 1 by cutting the fuel supply (step SB4) and rewriting the idle-stop flag F from “0” to “1” (step SB5). Herein, the respective processing of the steps SB1-SB5 correspond to the steps SA1-SA5 of the flowchart (FIG. 4) of the previously-described first embodiment.

After rewriting the idle-stop flag F from “0” to “1” in the step SB5, the PCM 10 determines whether or not the engine 1 completely stops, that is, the PCM 10 executes processing of determining whether or not the speed of the engine 1 is zero (step SB6). Then, at the timing the determination is YES and it is confirmed that the engine 1 has completely stopped, the PCM 10 sets a timer counter for measuring a stop time T1 of the engine 1 at zero (step SB7), and starts count-up processing of increasing the timer counter according to the time passing (step SB8).

In the time charts of FIG. 5, the timing the idle-stop requirement is met is denoted by t0′, and the timing the engine 1 completely stops is denoted by t1′. As shown in FIG. 5, the idle-stop flag F is rewritten from “0” to “1” at the timing t0′.

When the idle-stop flag F is rewritten from “0” to “1” as descried above, the determination made in the above-described step SB2 is NO. In this case, the PCM 10 executes processing of determining whether or not the idle-stop cancelation requirement is met (step SB9). Herein, the idle-stop cancelation requirement includes, additionally to the requirements of the accelerator and the brake operations, a requirement that the total time of the engine's stop after the idle stop (the total of the time when the engine 1 stops, which is obtained by adding the time T1 to the time T2 which will be described) reaches a specified upper-limit value.

When the determination made in the step SB9 is NO and it is confirmed that the idle-stop cancelation requirement has not been met yet, the PCM 10 executes processing of determining whether or not the voltage (Vcap) of the capacitor 3 which is obtained in the above-described step SB1 is smaller than the predetermined lower-limit value Vs (step SB13).

When the determination made in the step SB13 is YES and it is confirmed that the voltage of the capacitor 3 has become smaller than the lower-limit value Vs, the PCM 10 executes processing of stopping the count-up of the timer measuring the above-described stop time T1 (step SB14).

In the time charts of FIG. 5, the timing the voltage of the capacitor 3 decreases below the lower-limit value Vs is denoted by t2′. Herein, the engine 1 is restarted right after the timing t2′ (step SB17 which will be described later), so the timing t2′ corresponds to the timing the engine 1 is restarted. Accordingly, the time which is determined by the count-up stop in the step SB14, that is, the time which has passed from the timing t1′ the engine 1 completely stops to the timing t2′ the voltage decreases below the lower-limit value Vs, is the term (denoted by T1 in FIG. 5) when the stop state of the engine 1 lasts.

Next, the PCM 10 executes processing of calculating a remaining time T2 of the engine's stop based on the timer counter determined in the step SB14, that is, the stop time T1 of the engine 1 from the timing t1′ to the timing t2′ (step SB15). Herein, the remaining time T2 is the time which remains until the total stop time of the engine 1 reaches the predetermined upper-limit value, which is obtained by subtracting the stop time T1 of the engine 1 from the above-described upper-limit value of the total stop time.

Thus, according to the present embodiment, as described in the above-described idle-stop cancelation requirement (step SB9), the total stop time after the idle stop, that is, the total time of the engine being able to stop during the term from the timing the idle-stop requirement is met to the timing the idle-stop cancelation requirement is met is controlled below the predetermined upper-limit value. This is to provide an appropriate restart of the engine 1 (if the total stop time is improperly long, the engine may not have a smooth restart) and the like, and therefore about two minutes may be set as the above-described upper-limit value, for example. And, in the step SB15, the value obtained by subtracting the first stop time T1 from the upper-limit value of the total stop time is set as the remaining time T2 of the engine's stop.

When the remaining time T2 is determined as described above, the PCM 10 executes processing of calculating a target time Tw of the engine's operation after the engine's restart which is conducted in the next step SB17 for ensuring the power based on the above-described remaining time T2 (step SB16). Specifically, the operation target time Tw is set in proportion to the remaining time T2 (that is, the time Tw is set at a longer time when the time T2 is longer).

Next, the PCM 10 executes processing of restarting the engine 1 by operating (driving) the starter motor 7 and recovering the fuel supply to the engine 1 (step SB17). At the same time, the PCM 10 inputs the operation target time Tw calculated in the step SB16 as an initial value of the time counter, and then starts countdown processing of decreasing the timer counter in accordance with the time passing (step SB18).

When the engine is restarted in the step SB17, the power generation by the alternator 2 is restarted and the voltage of the capacitor 3 comes to increase. Thereby, the determination made in the step SB13 is NO. In this case, the PCM 10 executes processing of determining whether or not the timer counter decreasing has become zero, that is, whether or not the time passing after the restart of the engine 1 has reached the operation target time Tw (step SB19). When the determination made here is YES and it is confirmed that the time has reached the operation target time Tw, the PCM 10 executes processing of stopping the engine 1 again by cutting the fuel supply to the engine 1 (step SB20). Herein, the determination made in the step SB19 being YES (the engine 1 is operated during the time Tw) means that the voltage of the capacitor 3 has recovered sufficiently and also the specified requirement has been met according to the present invention.

In the time charts of FIG. 5, the timing the voltage of the capacitor 3 decreases below the lower-limit value Vs and the engine 1 is restarted is denoted by t2′, and the timing the operation target time Tw has passed from the timing t2′ is denoted by t3′. The timer count of the timer starting its countdown at the timing t2′ becomes zero at this timing t3′. Accordingly, at this timing, the cutting of fuel supply is executed, so that the speed of the engine 1 starts decreasing again. After this, the engine 1 comes to stop completely shortly after the timing t3′.

As described above, the engine 1 restarted for the power generation of the capacitor 3 is operated temporarily for the operation target time Tw which is set according to the remaining time T2 of the engine's stop, and then stopped again. The alternator 2 is operated according to the temporary restart of the engine 1, and thereby the power is supplied to the capacitor 3. Accordingly, the voltage of the capacitor 3 is recovered gradually according to the time passing during the time Tw.

After the engine 1 is stopped again at the timing t3′, the stop state of the engine 1 can be maintained for the remaining time T2 calculated in the step SB15. If the voltage of the capacitor 3 decreases below the lower-limit value Vs again during this reaming time T2, the engine 1 is restarted again for the power generation of the capacitor 3 at this point. In the example shown in FIG. 5, the remaining time T2 has already passed at the timing t4′ which is prior to the timing the voltage of the capacitor 3 decreases below the lower-limit value Vs. When the remaining time T2 has passed, the total stop time of the engine 1 has reached the upper-limit value. Therefore, the idle-stop cancelation requirement (SB9) has been met.

When the idle-stop cancelation requirement has been met (that is, the determination made in the step SB9 is YES), the PCM 10 executes processing of restarting the engine 1 by operating (driving) the starter motor 7 and recovering the fuel supply to the engine 1 (step SB10). Further, at the same time, the PCM 10 executes processing of rewriting the idle-stop flag F from “1” to “0” and processing of clearing the above-described times T1, Tw, T2 (steps SB11, SB12). Accordingly, as shown after the timing t4′ in the time charts of FIG. 5, the engine 1 is restarted, and the operation of the engine 1 continues until the idle-stop requirement has been met.

As described above, according to the second embodiment, when the voltage of the capacitor 3 decreases below the lower-limit value Vs during the stop of the engine 1, the engine 1 is restarted to recover the voltage of the capacitor 3, and then the engine 1 is stopped again at the timing the operation time reaches the target time Tw. Thereby, similarly to the first embodiment, the necessary voltage of the capacitor 3 can be ensured, and also the operation chance of the idle stop can be enlarged.

That is, according to the second embodiment, since the engine 1 is restarted when the voltage of the capacitor 3 decreases below the lower-limit value Vs, the voltage of the capacitor 3 can be kept above the lower-limit value Vs all the time. Further, since the engine 1 is stopped again at the timing the passing time from the engine's restart reaches the target time Tw so that it can be presumed that the voltage of the capacitor 3 has been recovered sufficiently, the sufficient voltage for making the electric load 4 operate properly can be ensured and also the improving of the fuel economy by means of the idle stop can be achieved properly.

According to the second embodiment, in particular, since the operation target time Tw of the engine 1 restarted for storing the power at the capacitor 3 is set variably in accordance with the time (remaining time of the engine's stop) T2 which remains until the total stop time of the engine 1 after the ide stop reaches the upper-limit value, the power stored (charged) at the capacitor 3 by the restart of the engine 1 can be increased more as the time of the stop time (remaining time) of the engine 1 becomes longer. Accordingly, the appropriate amount of power which corresponds to the power which may be consumed while the engine is stopped can be properly generated by the alternator 2.

The present invention should not be limited to the above-described embodiments, and any other modifications or improvements may be applied within the scope of a spirit of the present invention.

For example, while the above-described second embodiment does not refer to the setting of the specific value of the engine speed (the engine speed at the timings t2′-t3′ shown in FIG. 5) at the engine being restarted temporarily during the engine's stop by means of the idle stop, the engine speed may be set variably in accordance with the magnitude of the power which the electric load 4 consumes, as described above regarding the first embodiment. That is, the time (the time T1 of FIG. 5) which has passed from the stop of the engine 1 to the timing the voltage of the capacitor 3 decreases below the lower-limit value Vs is detected, or the decrease rate α of the voltage of the capacitor 3 which decreases during the stop of the engine 1 (the timings t1′-t2′), and then the engine speed at the time of temporary restart may be set in accordance with either of these two.

While the alternator 2 is used as the generator which is driven by the engine 1 and generates the power in the above-described first and second embodiments, a motor generator capable of doing a torque assist of the engine 1 (applying a torque for assist to the output shaft of the engine 1) additionally to the power generation may be used alternatively. That is, the present invention is applicable not only to a normal vehicle equipped with only an engine as a drive source, but also to a hybrid vehicle equipped with both the engine and a motor (motor generator).

Also, while the electric double-layer capacitor (EDLC) is used as the power-storage device to store the power generated by the alternator 2 (generator) in the above-described embodiments, any other type of power-storage device can be applied as long as it is chargeable/dischargeable repeatedly.

For example, the Lithium ion capacitor is useable as the power-storage device in place of the electric double-layer capacitor, which can further improve the energy density by using a carbon-based material capable of storing a Lithium ion electrochemically (the same material as a negative electrode of a Lithium-ion battery) as a negative electrode. This Lithium ion capacitor has a difference in the law (principle) of charging/discharging between a positive electrode and a negative electrode, which is different from the normal electric double-layer capacitor and therefore called a hybrid capacitor. Both this hybrid capacitor, of which the Lithium ion capacitor is one example, and the above-described electric double-layer capacitor have the high energy density as well as the linear charging/discharging properties, so that these may be preferable as the power-storage device.

What is claimed is:

1. A power-source apparatus for a vehicle, comprising:
a generator driven by an engine of the vehicle having a function of an idle stop and generating power;
a power-storage device storing the power generated by the generator thereat; and
a control device controlling a stop of the engine, a restart of the engine, and a generation operation of the generator,
wherein said power-storage device supplies the power to an electric load of the vehicle when the engine is stopped by means of the idle stop, and
said control device is configured to restart the engine when a voltage of the power-storage device decreases below a lower-limit value after the engine is stopped by means of the idle stop, and stop the engine again when a specified requirement for determining a sufficient recovery of the voltage of the power-storage device by means of the engine's restart is met.

2. The power-source apparatus for a vehicle of claim 1, wherein said power-storage device is a capacitor.

3. The power-source apparatus for a vehicle of claim 1, wherein said specified requirement is that the voltage of said power-storage device exceeds a threshold which is higher than said lower-limit value.

4. The power-source apparatus for a vehicle of claim 3, wherein said threshold is set valuably in accordance with a decrease rate of the voltage of the power-storage device which decreases when the engine is stopped by means of the idle stop.

5. The power-source apparatus for a vehicle of claim 2, wherein said specified requirement is that the voltage of said power-storage device exceeds a threshold which is higher than said lower-limit value.

6. The power-source apparatus for a vehicle of claim 5, wherein said threshold is set valuably in accordance with a decrease rate of the voltage of the power-storage device which decreases when the engine is stopped by means of the idle stop.

7. The power-source apparatus for a vehicle of claim 1, wherein said specified requirement is that an operation time of the engine after the engine is restarted reaches a specified time.

8. The power-source apparatus for a vehicle of claim 7, wherein said control device is configured to cancel the idle stop when a total time of the engine being stopped after the idle stop reaches an upper-limit value, and set said specified time variably in accordance with a remaining time which is obtained by subtracting, from said upper-limit value, a time of the engine being stopped until the voltage of said power-storage device decreases below said lower-limit value.

9. The power-source apparatus for a vehicle of claim 2, wherein said specified requirement is that an operation time of the engine after the engine is restarted reaches a specified time.

10. The power-source apparatus for a vehicle of claim 9, wherein said control device is configured to cancel the idle stop when a total time of the engine being stopped after the idle stop reaches an upper-limit value, and set said specified time variably in accordance with a remaining time which is obtained by subtracting, from said upper-limit value, a time of the engine being stopped until the voltage of said power-storage device decreases below said lower-limit value.

11. The power-source apparatus for a vehicle of claim 1, wherein said control device is configured to set an engine speed after the engine's restart variably in accordance with a time which has passed from the engine's stop to the timing the voltage of the power-storage device decreases below said lower-limit value.

12. The power-source apparatus for a vehicle of claim 1, wherein said control device is configured to set an engine speed after the engine's restart variably in accordance with a decrease rate of the voltage of the power-storage device which decreases when the engine is stopped by means of the idle stop.

13. A control method of a power-source apparatus for a vehicle which comprises a generator driven by an engine of the vehicle having a function of an idle stop and generating power and a power-storage device storing the power generated by the generator thereat, and the power is supplied from the power-storage device to an electric load of the vehicle when the engine is stopped by means of the idle stop, the method comprising steps of:
restarting the engine when a voltage of the power-storage device decreases below a lower-limit value after the engine is stopped by means of the idle stop; and
stopping the engine again when a specified requirement for determining a sufficient recovery of the voltage of the power-storage device by means of the engine's restart is met.
